(19) United States
(12) Patent Application Publication
(10) Pub. No.: US 2002/0164438 A1
(43) Pub. Date: Nov. 7, 2002

(54) Plastic multi-colored pasta shapes

(76) Inventor: Christine Marie Ondris, Vernon, NJ (US)

Correspondence Address: CHRISTINE M. ONDRIS, P.O. BOX 693, McAfee, NJ, 07428, US

(21) Appl. No.: 09/850,641

(22) Filed: May 7, 2001

(51) Int. Cl. A41G 3/00; B29C 41/22

(52) U.S. Cl. 428/15; 264/78

(57) ABSTRACT

FIG. 1 is a front view of plastic shaped pasta (ziti, rigatoni, penne, ditalini) used for crafting a necklace;

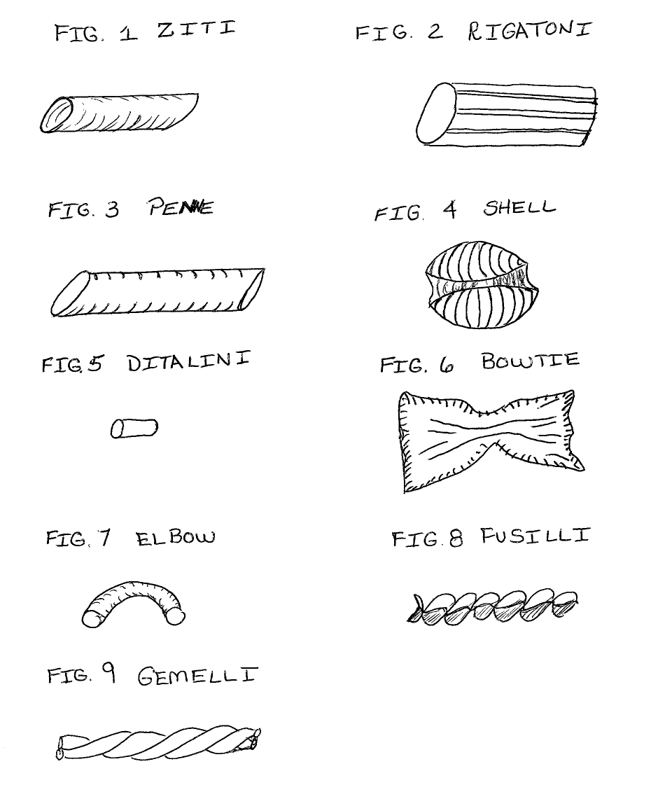

FIG. 2 is a front view of plastic shaped pasta (shell, bowtie, elbow, fusilli, gemelli) used for crafting a picture frame;

I claim: the use of plastic, multi-colored pasta for craft kits as shown.

### CROSS-REFERENCE TO RELATED APPLICATIONS

Not Applicable

### STATEMENT REGARDING FEDERALLLY SPONSORED RESEARCH OR DEVELOPMENT

Not Applicable

### REFERENCE TO A MICROFICHE APPENDIX

Not Applicable

### BACKGROUND OF THE INVENTION

Class 264

Plastic and Nonmetallic Article Shaping or Treating Process

Process for molding, casting and or plastic shaping of plastic material to make or reproduce articles of a definite shape, in this case, plastic shaped pasta product. Each mold will have a particular shape and will retain molded shape after it is removed from the enclosed material.

Subclass: 78

Process which includes the step of dyeing an article or workpiece, in this case, the pasta shaped plastic product which is dye susceptible and when spun into a coagulatory bath which contains a reactant for the dye susceptible material, will produce color.

Class 446

Amusement Devices: Toys

Principle purpose is for the amusement or recreation of children, wherein there is physical interaction between the person and the device.

### BRIEF SUMMARY OF THE INVENTION

Molded plastic colored pasta shapes for recreation use (craft kits) including the making of necklaces, bracelets, frames and magnets.

Currently, standard uncooked pasta to use for crafts is very difficult to color (an involved painting process) and breaks easily because it is uncooked food product. Manufacturing precolored, plastic pasta shapes would eliminate the use of painting pasta and using food product for craft use.

### BRIEF DESCRIPTION OF THE SEVERAL VIEWS OF THE DRAWING

1. Ziti pasta shape

2. Rigatoni pasta shape

3. Penne pasta shape

4. Shell pasta shape

5. Ditalini pasta shape

6. Bowties (Farfalle) pasta shape

7. Elbow Macaroni pasta shape

8. Fusilli pasta shape

9. Gemelli pasta shape

### DETAILED DESCRIPTION OF THE INVENTION

A plastic molding company to create the pasta shapes will use existing or custom molds of the various pasta shapes. The plastic pasta shapes will be dye susceptible and will be spun in a bath to produce the various colors.

After the shapes are manufactured, kits will be constructed for craft activities including but not limited to Plastic Pasta Jewelry Kit, Plastic Pasta Frame Kit, Plastic Pasta Magnet Kit or the plastic pasta shapes will be sold in bulk.

1. What I claim, as my invention is the concept, molding (casting or shaping), dyeing and manufacture of plastic pasta shapes in various colors for recreational use, primarily craft kits (not for food consumption).
